(19) United States
(12) Patent Application Publication
(10) Pub. No.: US 2006/0168014 A1
(43) Pub. Date: Jul. 27, 2006

(54) Highly extendable message filtering daemon for a network appliance

(75) Inventor: Bing Wang, San Jose, CA (US)

Correspondence Address: DARBY & DARBY P.C., P.O. BOX 5257, NEW YORK, NY, 10150-6257, US

(73) Assignee: Nokia Inc., Irving, TX (US)

(21) Appl. No.: 10/999,305

(22) Filed: Nov. 30, 2004

(51) Int. Cl. G06F 15/16

(52) U.S. Cl. 709/206

(57) ABSTRACT

A method for providing a filtering service to a front-end processing daemon (FD) in a messaging system independently of the FD. A front-end filtering daemon (FFD) is configured to accept filtering requests from at least one FD through a front-end filtering client (FFC) residing the at each FD, and send back results after executing the requests. Pre-formatted requests and replies are employed between the FFC and the FD. Requests are classified in pre-defined categories and prioritized according to their category. The FFD may reside at another device and support a plug-in architecture enabling an administrator to modify a plurality of filtering plug-ins. Each plug-in may include at least one filtering function. A handler list maintained by the FFD is employed to sort incoming requests and direct to the appropriate plug-ins. Negative results from plug-ins are then reported to the FD as a rejection along with an error code.

### FIELD OF THE INVENTION

The present invention relates to network communications, and in particular, to a method and device for providing a filtering service to a front-end daemon processing independently of the front-end processing daemon.

### BACKGROUND

Most computer operating systems include a mechanism for executing server programs. These server-programs are used to provide services to other, possibly networked, client-programs. The server-programs generally do not interact with a user. Instead, a client-program requests the server-program to perform an operation. The server-program performs the requested operation and generally returns a result to the client-program. These server-programs are commonly referred to as “daemon” programs and are subsequently defined. The daemon program is often invoked when the operating system initializes. When the daemon program starts execution, it may access command line options and/or read a preference or initialization file to further configure its operation. Daemon programs often provide services that are similar to operating system services. One example of a daemon program is an HTTP server program that provides World Wide Web (WWW) page services for web page resources over the Internet.

A daemon architecture may also include a connection to a network. The communication through the network may be, but need not be, totally contained within the computer hosting the server daemon program. The server daemon program may provide a service for multiple applications. These may include a web site, a messaging application, and the like. In a messaging application, the daemon program may provide a variety of services including, but not limited to filtering, authorization, authentication, other security related tasks, sorting related tasks, and the like.

Commonly, daemon programs are resident in a server that supervises the associated application or applications. Thus, the operating characteristics for the daemon program may only be changed at the server for the application(s). In such a scenario, a client may only submit change requests to an administrator of the application server to be implemented in the relevant daemon program. Consequently, performing administrative functions on the daemon program may affect the availability of the services for the resources provided by the daemon program. Such administrative functions may include reconfiguration of the daemon program, performance tuning of the daemon program, and performance monitoring of the daemon program.

Another aspect of the advent of large scale distributed computer systems, such as the Internet, is an explosion of the amount of information which has become available to users of computer systems. Among this information is electronic mail (e-mail). With the improvements in means for composing and distributing written messages, the amount of e-mail traffic on the Internet has surged. It is not unusual for an active Internet user to be exposed to tens of thousands of e-mail messages a year.

As a disadvantage, Internet users may receive junk-mail whenever they send to mailing lists or engage in news groups. There are numerous incidents where specific users have been overwhelmed by thousands of unwanted mail messages. New filtering systems are being developed continuously to deal with this deluge.

Known distributed systems for composing and accessing e-mail are typically built around protocols such as Internet Messaging Access Protocol (IMAP), Post Office Protocol (POP), or Simple Mail Transfer Protocol (SMTP). Typically, users must install compatible user agent software on any client computers where the mail service is going to be accessed. Often, a significant amount of state information is maintained in the users' client computers. For example, it is not unusual to store the entire mail database for a particular user in his desk-top or laptop computer.

Service providers, which provide messaging service such as email, instant messaging, and the like, compete in providing more user-friendly and less burdensome messaging services in addition to features such as price, throughput, and capacity. This requires a variety of filtering functions to be performed by the service provider. Typically, a service provider may utilize a hardware and/or software backbone of another provider for messaging services. In such cases, the service provider acting as a client may prefer flexibility in modifying features of filtering programs, and have more control over the administration of the messaging application. The same may also apply in a setting of individual clients' interaction with a service provider.

Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates a system representing an environment in which one embodiment of the present invention may operate;

FIG. 2 illustrates a block diagram of a messaging server in which one embodiment of the present invention may be implemented;

FIG. 3 illustrates a diagram of a messaging system architecture in which one embodiment of the present invention may be implemented;

FIG. 4 illustrates a diagram of the architecture of one embodiment of a front-end filtering daemon according to the present invention;

FIG. 5 illustrates a diagram of an exemplary handler list according to one embodiment of the front-end filtering daemon of FIG. 4;

FIG. 6 illustrates a diagram of a front-end filtering operation according to the exemplary handler list of FIG. 5; and

FIG. 7 illustrates a flow diagram of a front-end filtering process according to one embodiment of the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed to a method for providing a filtering service to a front-end daemon in a messaging system independently of the front-end daemon. A filtering daemon may be configured to accept filtering requests from at least one front-end daemon and send back results after executing the request. Information between the front-end daemon and filtering daemon may be exchanged in the form of pre-formatted requests and replies. Requests may be classified in pre-defined categories and prioritized according to their category. The filtering daemon may reside at a client and support a plug-in architecture enabling the client to modify and select a plurality of filtering plug-ins. Each filtering plug-in may include at least one filtering function. A handler list maintained by the filtering daemon may be employed to sort incoming requests and direct the requests to appropriate plug-ins. Negative results from plug-ins may then be reported to the front-end daemon as a rejection along with an error code.

For many network appliances, a front-end daemon, which is designated to receive incoming messages (e.g. SMTP, MMS or HTTP messages), may be third-party open source software. To provide higher security and more functionality, vendors of these appliances may add extra filtering features into the third party software. If the third party software is open source, a common way of adding new filtering features is integrating the features directly into the third party software, such as mail flood prevention filter and front-end anti-spam filter. However, this integration approach may have its drawbacks, including replacing front-end daemons with new ones without having to reintegrate filtering features, version updates between front-end daemons and filtering software, software licensing issues, and/or sharing of filtering services among multiple front-end devices. Furthermore, a language dependency of integrated systems may restrict a pool of available front-end implementations.

According to one aspect of the present invention a common framework for front-end filtering of a network appliance is laid out. An easier to maintain, more extendable, more flexible, more efficient, and substantially language-independent front-end filtering system is proposed in one embodiment of the present invention.

While examples of Simple Mail Transfer Protocol (SMTP), HyperText Transfer Protocol (HTTP), and Multimedia Messaging Service (MMS) structures are used in describing embodiments of the invention below, the invention is not so limited. Methods and algorithms described below may be implemented for other types of messaging systems known to those skilled in the art.

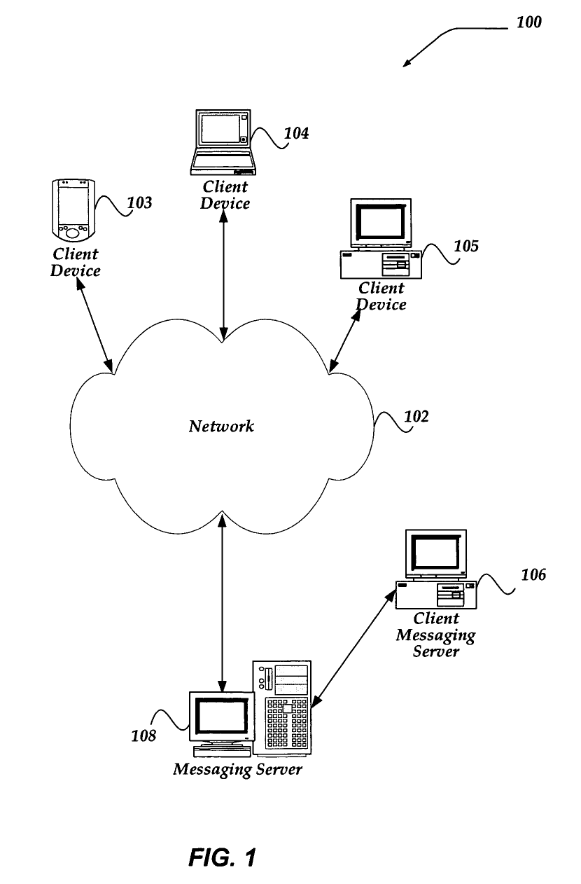

FIG. 1 illustrates system 100 representing an environment in which one embodiment of the present invention may operate. However, not all of these components may be required to practice the invention, and variations in the arrangement and type of the components may be made without departing from the spirit and scope of the invention.

As shown in the figure, system 100 includes network 102, client devices 103-105, messaging server 108, and client messaging server 106. Network 102 represents any network including the Internet, and enables communication between client devices 103-105, as well as between client devices 103-105 and network devices, including network devices connected to other networks that are in communication with network 102.

Generally, client devices 103-105 may include virtually any computing device capable of connecting to another computing device to send and receive information, including emails, and other interactive information. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, radio frequency (RF) devices, infrared (IR) devices, integrated devices combining one or more of the preceding devices, or virtually any mobile device. Similarly, client device 102 may be any device that is capable of connecting using a wired or wireless communication medium such as a PDA, POCKET PC, wearable computer, and any other device that is equipped to communicate over a wired and/or wireless communication medium.

Client devices 103-105 may further include a client application that is configured to manage the actions described above in association with client devices 103-105. Moreover, client devices 103-105 may also include a web browser application that is configured to enable an end-user to interact with other devices and applications, over network 102. In one embodiment, the web browser may be configured to provide various functions, including, but not limited to, authentication, ability to enable an end-user to customize a web browsing feature, and synchronization with another web browser application. The web browser may further enable inputs, such as a keyboard input, a mouse input, an audio input, and the like.

Network 102 is configured to couple client devices 103-105 among themselves, with other client devices, and to messaging server 108. Network 102 may also be coupled to other networks and enable communication between devices connected to network 102 and devices connected to other networks. Network 102 is enabled to employ any form of computer readable media for communicating information from one electronic device to another. In one embodiment, network 102 is the Internet, and may include local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links.

Network 102 may further employ a plurality of wireless access technologies including, but not limited to, 2nd generation (2G), 3rd generation (3G) radio access for cellular systems, Wireless-LAN, Wireless Router (WR) mesh, and the like. Access technologies such as 2G, 3G, and future access networks may enable wide area coverage for mobile devices, such as client device 102 with various degrees of mobility. For example, network 102 may enable a radio connection through a radio network access such as Global System for Mobil communication (GSM), General Packet Radio Services (GPRS), Enhanced Data GSM Environment (EDGE), Wideband Code Division Multiple Access (WCDMA), 802.16, and the like.

Furthermore, remote computers and other related electronic devices could be remotely connected to either LANs or WANs via a modem and temporary telephone link. In essence, network 102 includes any communication method by which information may travel between client devices 103-105 and other network devices.

Additionally, network 102 may include communication media that typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

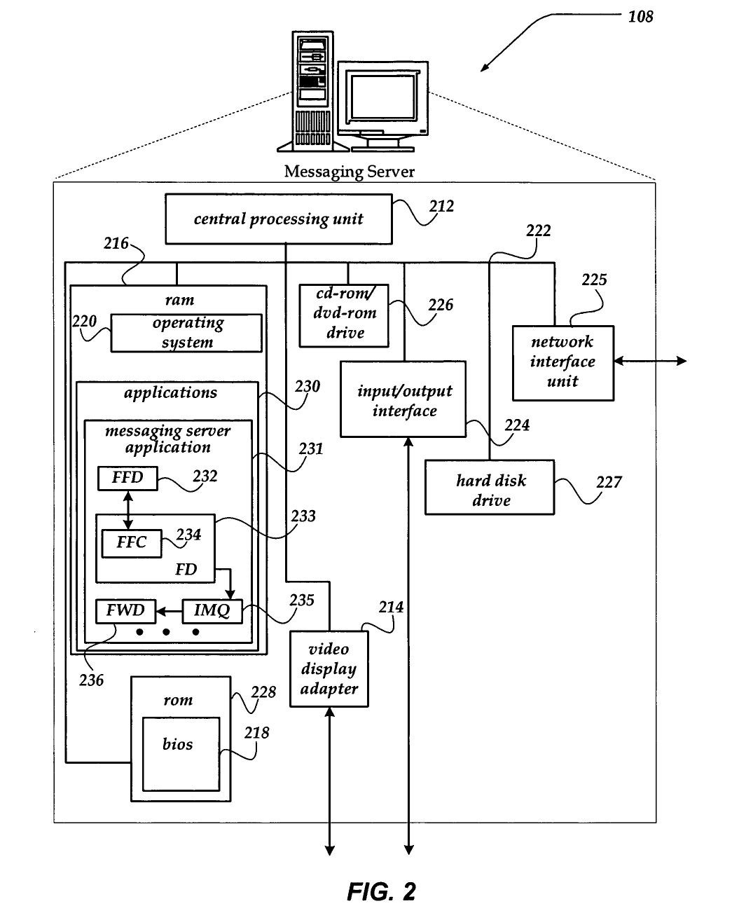

Messaging server 108 is described in more detail below in conjunction with FIG. 2. Briefly, however, messaging server 108 includes virtually any network device configured to provide messaging services. As such, messaging server 108 may be implemented on a variety of computing devices including personal computers, desktop computers, multiprocessor systems, microprocessor-based devices, network PCs, servers, network appliances, and the like.

Messaging server 108 may further be configured to provide secured communication for interactions, various security, and administrative control services, including but not limited to, authentication, load balancing, and the like. For example, messaging server 108 may be configured to filter data received by a particular network device. In one embodiment, messaging server 108 may communicate with other devices through a secure or unsecure channel.

Client messaging server 106 includes virtually any network device configured to provide supervision of messaging services for a client device and/or system. As such, client messaging server 106 may be implemented on a variety of computing devices including personal computers, desktop computers, multiprocessor systems, microprocessor-based devices, network PCs, servers, network appliances, and the like.

Client messaging server 106 may further be configured to provide secured communication for interactions, various security and administrative control services, including but not limited to, authentication, load balancing, and the like. For example, client messaging server 106 may be configured to interact through a secure or unsecure channel with messaging server 108 and control particular aspects of messaging services for client devices and/or applications associated with client messaging server 106.

FIG. 2 illustrates a block diagram of messaging server 108, in which one embodiment of the present invention may be implemented. Messaging server 108 may include many more components than those shown. The components shown, however, are sufficient to disclose an illustrative embodiment for practicing the invention.

Messaging server 108 includes central processing unit 212, video display adapter 214, and a mass memory, all in communication with each other via bus 222. The mass memory generally includes RAM 216, ROM 232, and one or more permanent mass storage devices, such as hard disk drive 227, CD/DVD-ROM drive 226, tape drive, optical drive, and/or floppy disk drive (not shown). The mass memory stores operating system 220 for controlling the operation of messaging server 108. Any general-purpose operating system may be employed. As illustrated in FIG. 2, messaging server 108 also can communicate with the Internet, or some other communications network, such as network 102 in FIG. 1, via network interface unit 225, which is constructed for use with various communication protocols including the TCP/IP protocols. Network interface unit 225 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

RAM 216 also stores program code and data. One or more applications 230 are loaded into mass memory and run on operating system 220. Examples of application programs may include transcoders, schedulers, graphics programs, database programs, word processing programs, user interface programs, various security programs, and so forth. Applications 230 may further include messaging server application 231.

Messaging server application 231 may be configured to perform messaging operations over network 102 of FIG. 1. In one embodiment, messaging server application 231 may include Front-end Filtering Daemon (FFD) 232, Front-end Daemon (FD) 233, which may include Client front-end filtering daemon (FFC) 234, and Forwarding Daemon (FWD) 236. FD 233 is configured to receive messages from one or more clients. FFD 232 is configured to process filtering requests from FD 233. FFC 234 may be coupled to FD 233 and be configured to exchange requests and replies employing a pre-defined format. Messages that successfully pass filtering process may be stored into IMQ 235 by FD 233, and subsequently picked up by FWD 236 for further transmission, routing, and the like. In one embodiment, FFD 232 may include filtering plug-ins that performs individual filtering tasks. FFD 232 may reside in a client device or application such as client messaging server 106 of FIG. 1, in one embodiment.

Messaging server 108 may further include other messaging applets and modules such as an Element Management Application (EM), filtering plug-ins, Graphical User Interface (GUI), and the like.

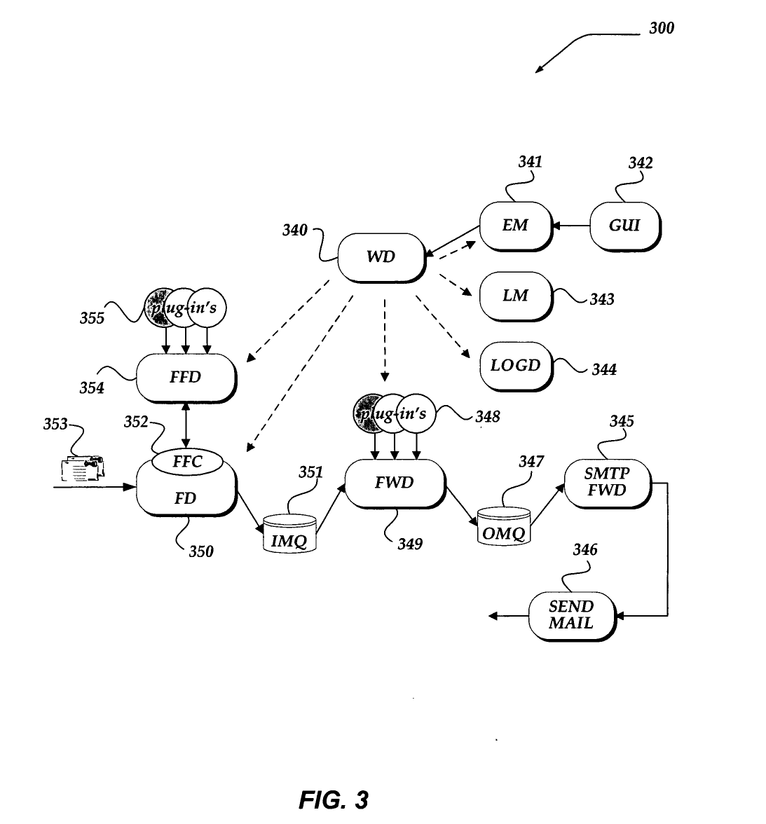

FIG. 3 illustrates diagram 300 of a messaging system architecture in which one embodiment of the present invention may be implemented. Diagram 300 includes watchdog application (WD) 340 Element Management Application (EM) 341, Graphical User interface (GUI) 342 for EM 341, License Management (LM) 343, Log Daemon (LOGD) 344, SMTP Forwarding Appliance (SMTPFWD) 345, Mail Transmission Appliance (SENDMAIL) 346, Outgoing Mail Queue (QMO) 347, Forwarding Daemon (FWD) 349, Plug-ins 348 for FWD, Incoming Message Queue (IMQ) 351, Front-end Daemon (FD) 350, Client front-end filtering daemon (FFC) 352, incoming messages 353, Front-end Filtering Daemon (FFD) 354, and Plug-ins 355 for FDD 354.

WD 340 is a higher level application tasked with supervision and coordination of various appliances in a messaging system. Some of the applications peripherally involved with messaging operations may include LM 343 and LOGD 344. EM 341 may provide input to WD 340 from an administrator employing GUI 342.

A main messaging path in messaging system diagram 300 begins with incoming messages 353. Incoming messages 353 may include email, MMS messages, instant messages, and the like. FD 350 is arranged to receive incoming messages and perform preliminary (front-end) filtering and sorting tasks. Such tasks may include, but not be limited to, filtering according to client address, message size, message type, and the like. FFC 352 is arranged to exchange filtering requests and replies with FFD 354 employing a pre-defined format. In one embodiment, FFC 352 may be a module residing within FD 350. In another embodiment, FFC 352 may reside on another application such as client messaging application.

FFD 354 is a server program responsible for performing front-end filtering tasks such as those described above. FFD 354 may reside in the same messaging server as the rest of messaging appliances, in a client device, a third party messaging server, and the like. By being independent from FD 350 and exchanging filtering requests and replies according to a pre-defined format, FFD 354 essentially becomes a user-replaceable filtering module. Because FFD 354 is independent from FD 350, filtering features may be added, removed, and modified without affecting FD 350. Language and maintenance of FFD 354 may be independent from FD 350, and filtering service may be shared among multiple FD's. Various filtering features may be coupled to FFD 354 as plug-ins 355.

In an operation, FFC 352 may send a request for filtering to FFD 354 upon receiving a message. After performing the filtering task, FFD 354 may send back a reply indicating acceptance or rejection. If the message is accepted, FD 350 may forward it to IMQ 351. When processing capacity is available, FWD 349 may receive the message from IMQ 351 and perform a number of further tasks. Tasks performed by FWD 349 may include, but not limited to, scanning for viruses, performing content checks, and the like. Individual tasks such as virus scan appliance, additional filtering appliances may be provided to FWD 349 as plug-ins 348.

Once FWD 349 completes its tasks on the message, the message is stored into OMQ 347. SMTPFWD 345 is arranged to pick up the message from OMQ 345 and forward to SENDMAIL 346. SMTPFWD 345 may perform tasks including adding, deleting, modifying SMTP-associated headers, and the like. SENDMAIL 346 is configured to forward the message to a next destination, which may include a router, a client, a firewall, and the like.

FIG. 3 shows an exemplary embodiment of a messaging system architecture. The invention is, however, not so limited. Other architectures may be implemented employing additional or fewer components without departing from the scope and the spirit of the invention.

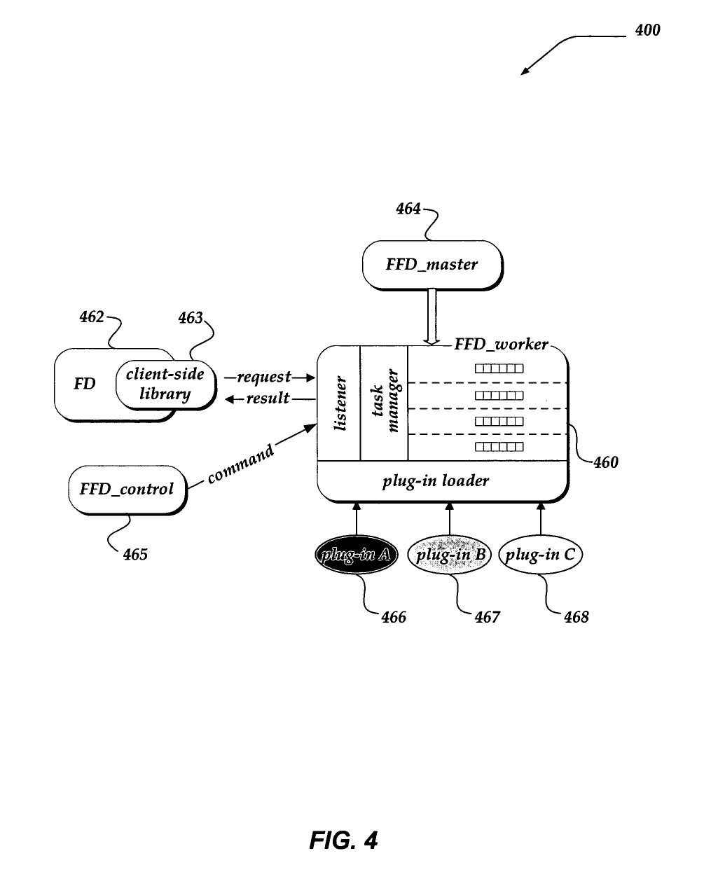

FIG. 4 illustrates diagram 400 of the architecture of one embodiment of a front-end filtering daemon along with a corresponding front-end daemon according to the present invention. Diagram 400 includes FD 462, Client-side Library 463, FFD_master 464, FFD_control 465, FFD_worker 460, plug-in A 466, plug-in B 467, and plug-in C 468. Client-side Library 463 is an exemplary embodiment of FFC 352 of FIG. 3.

The FFD may be a socket based server program, which is arranged to listen on a server port, to wait for filtering requests from its clients such as FFC, typically a module of FD, to process the received requests, and to send back filtering results.

For fail-over control and high availability, two processes, FFD_master 464 and FFD_worker 460, may be arranged to operate concurrently for the FFD component, where FFD_worker 460 is the process designated to handle routine tasks including, but not limited to, listening for requests, sending back results after processing, and the like, while FFD_master 464 serves as a watchdog process, and may be responsible for spawning FFD_worker 460, watching for its health, taking appropriate steps (such as restarting it) if FFD_worker 460 malfunctions.

FFD_worker 460 may be a multi-thread process. For efficiency, a pre-determined number of threads may be spawned in advance, and each thread may maintain a task queue. A task may be created for each filtering request, and queued in random by a task manager.

In addition to the FFD daemon, diagram 400 shows client-side library 463, front-end daemon (FD) 462, and FFD_control utility 465. Client-side library 463 is an example of FFC as described in FIG. 3, and may be used by FD 462 to communicate with the FFD. FFD_control utility 465 may be used to send a command to the FFD as described in more detail below.

FFD Processes:

FFD_master 464 is the master process of FFD, and is the first started process. FFD_master 464 may be responsible for:
Validating arguments, such as user ID, group ID, chroot directory, and etc.
Generating an authentication token.
Starting FFD_worker.
Monitoring FFD_worker's health.
Taking actions such as restarting FFD_worker 460 if FFD_worker 460 malfunctions or dies.
Receiving and interpreting signals sent by a user to stop, restart or debug the FFD service.

FFD_worker 460 may be spawned from FFD_master 464 as a child process to handle routine processing of requests, and may be functionally composed of task manager, plug-in loader, request listener, and the like.

Request listener may be a communication front-end of FFD_worker 460, and primarily responsible for receiving filtering requests from filtering clients (such as FFC) and management commands from FFD_control utility 465.

Task manager may be a central part of FFD_worker 460, and responsible for initialization of various functional modules of FFD_worker 460, scheduling of filtering requests, and processing of non-filtering requests.

During a startup, the task manager may:
Initiate a working environment, such as setting user ID, group ID, and root directory.
Initiate plug-in loader, which is arranged to load plug-ins and build plug-in lists
Create threads and task queues
Initiate request listener so that FFD_worker 460 is ready to accept requests.

During a runtime, the task manager may handle the requests received by the request listener based on the type of the request. If the request is a filtering request, the task manager may queue the filtering task into a task queue of a thread, which may process the request later; otherwise (i.e. a listing request or a managing request), the task manager may process the request immediately and send back a result of the processing.

Some request types may take significantly longer time to process than others. To avoid an imbalance in a number of tasks in the task queues, the filtering tasks may be queued randomly to the task queues of the threads. However, implementing the randomness of the queues by starting from a random thread after a cycle of assignments may provide improved performance.

Client-side library 463 may be a utility library, which can be used by FD 462 to send filtering requests to the FFD, and obtain filtering results. The library hides implementation details, such as communications between the FFC and the FFD, and FD 462 may obtain the filtering results by making only a few function calls to client-side library 463.

Client-side library 463 may be implemented in different programming languages. An example of client-side library 463 implemented in C making six functions available to a calling FD is shown below.

int init_ffc( );
int ffc_filter_ipv4 addr (struct in_addr *addr, char *msg,
int maxmsglen);
int ffc filter name (char *addr, char *msg, int maxmsglen);
int ffc_filter_envelope(F ENVELOPE *env, char *msg, int maxmsglen);
int ffc filter_msgsum(FMSG SUM *sum, char *msg, int maxmsglen);
int close_ffc( )

The init_ffc( ) function is called during FD's initialization, and close_ffc( ) is called when FD exits.

For each received message, the FD may call four filtering routines one by one right after each relevant information is available, typically in the order ffc_filter_ipv4 addr( ), ffc_filter name( ), ffc_filter_envelope( ), and ffc_filter_msgsum( ).

An input to FFC filtering functions is relevant data to be filtered, and an output is the filtering result, which may be an integer code with an error string if the code is not 0. If 0 is returned, message is accepted, and no action is to be taken. Otherwise, the message may be rejected. For a rejection, a connection can be aborted either immediately or after the FD chats the returned integer and error string to the messaging client following SMTP protocol.

Error handling may also be transparent to the calling FD. For example, if the FFD is down, a rejection may be returned and the connection aborted.

FFD_control is a management utility, which may be used by an administrator (or by management software programmatically) to send management commands (such as restart or reconfigure a particular plug-in) to the FFD.

Plug-in architecture may be applied in FFD design, and the filters loaded into the FFD as plug-ins. The plug-in approach may enable:
The plug-ins and the FFD to be developed separately and to implement a new plug-in without modifying the FFD.
Easier management of the filters by adding or removing a plug-with a minor change to a configuration file.

The filter plug-ins may be loaded by a plug-in loader during FFD_worker 460's startup. A particular plug-in such as plug-in A, B, or C, or all plug-ins may be reloaded if FFD_worker 460 is signaled to do so. Each plug-in may implement one or more filtering functions in addition to other mandated or optional functions.

Following are four exemplary filtering functions corresponding to four different types of filter actions that may be supported by an FFD, each of which taking one of following exemplary input data:

(1) IP address

(2) Domain name

(3) The envelope information of an email message

(4) Message summary, such as total size of message, connection time, etc.

Various examples of programs, filtering types, and the like are described above. However, the invention is not so limited. Other programs, programming languages, filter and data types may be employed without departing from the scope and the spirit of the present invention.

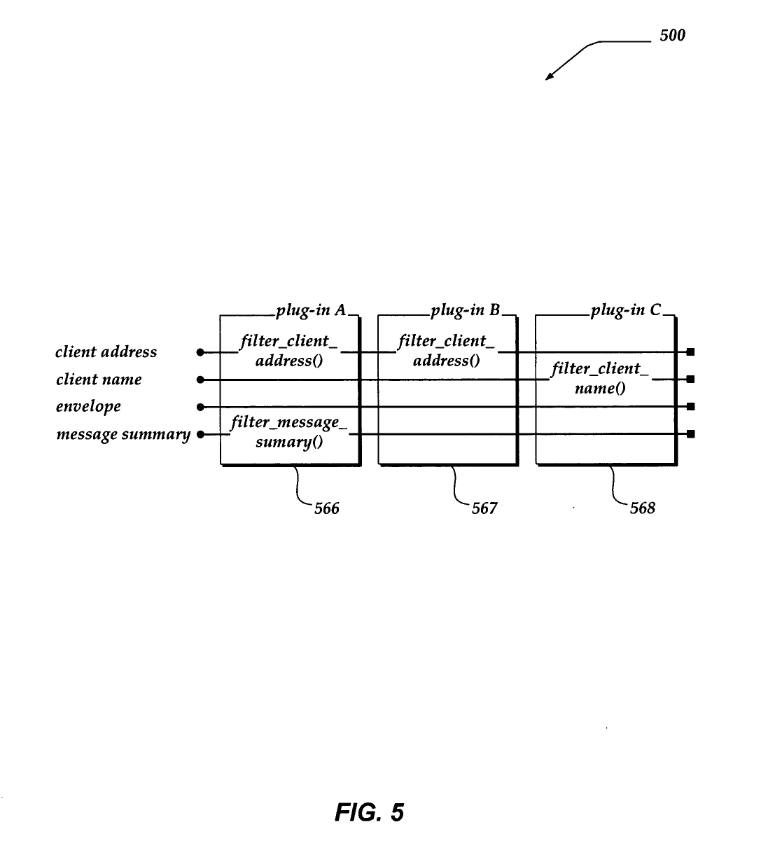

FIG. 5 illustrates a diagram of exemplary handler list 500 according to one embodiment of front-end filtering daemon 460 of FIG. 4. Exemplary handler list 500 includes list 566 for plug-in A, list 567 for plug-in B, and list 568 for plug-in C as well as exemplary attributes client address, client name, envelope, and message summary.

For efficiency, a plug-in loader may maintain a handler list such as handler list 500 for each supported filtering type in addition to a list of the plug-ins. The plug-in loader may resolve all implemented filtering functions of all loaded plug-ins in advance, and cache function pointers into corresponding handler list 500.

Unless handler list 500 is empty, for each received filtering request, the FFD may go through handler list 500 for the corresponding type, pass the input data in the filtering request to each of the functions one by one, and report a result of rejection if one of the functions returns a negative result, or pass if the end of hander list 500 is reached and no negative result is returned from any functions in handler list 500.

According to the example in FIG. 5, plug-in A includes filtering types filter_client_address( ) and filter_messge_summary( ). Plug-in B includes filter_client_address( ) only, and plug-in C includes filter_client_name( ). In a typical operation, the FFC may send a filtering client address request to the FFD, in this case, the FFD may apply plug-in A, which may determine if an incoming message includes a client address that is among a list of client addresses maintained by plug-in A, such as list 566. If the criteria is met, filtering may proceed to plug-in B, which may determine if the incoming message includes a client address that is among a list of client addresses, such as list 567 maintained by plug-in B. Plug-in C is not applied, because the filter_client_address( ) function is not implemented in it. A filter result will then be sent back to FFC. If the result is negative, the message is to be rejected. Otherwise, the FFC may send filtering client name request and filtering message summary request to FFD sequentially, and FFD apply filter_client_name( ) in plug-in C, filter_message_summary( ) in plug-in A accordingly, and send back the filtering results. If all filtering results received from FFD are acceptance, the FD may accept the message and store the message to the IMQ. On the other hand, if any of the filtering tasks fails, the reply may be one of rejection to the FD. For example, in the above example, if plug-in A filter_client_address( ) returns a negative result, plug-in B” filter_client_address( ) may not be executed, and the result may be returned immediately to the FFC. Moreover, if any of the results are negative, all tests thereafter may not be executed, and the message may be rejected.

FIG. 5 includes an exemplary handler list with four particular filter types and three plug-in modules. However, the invention is not so limited. Other filter types and number of plug-in modules may be employed without departing from the scope and the spirit of the present invention.

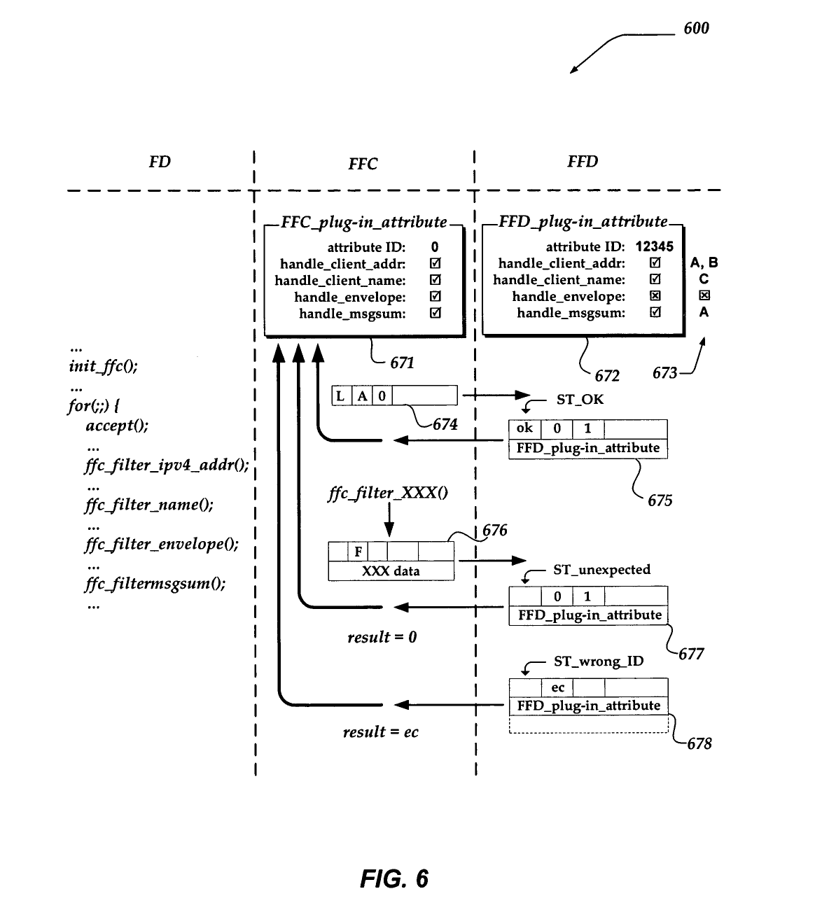

FIG. 6 illustrates diagram 600 of a front-end filtering operation according to exemplary handler list 500 of FIG. 5. FIG. 6 includes in a first column an exemplary program for an FD. A second column and a third column illustrate an interaction between an FFC and an FFD including FFC plug-in attribute 671 and FFD plug-in attribute 672 at the FFC and the FFD, respectively. The second and the third columns further include exemplary data structure diagrams 674-679 corresponding to various attributes.

Although the FFD may support a predetermined number of different filtering types and accept filtering requests of the different types, one or more of the handler lists may be empty. Therefore, processing the requests of the corresponding types may not be necessary (a positive result would always be the case). An empty handler list may occur when none of the loaded plug-ins implements the filtering function of the particular type. For instance, the handler list for envelope type may be empty in the example given in FIG. 6.

Network overhead may be reduced and CPU time saved, if the FFC is aware of whether the handler list for the particular type is empty and therefore always assume a positive result for the corresponding type without sending a filtering request to the FFD.

With a plug-in attribute distribution method, the FFC may be aware of which handler lists are empty on the FFD side, and be unlikely to send a request of those types to the FFD. However, if a request of these types is received, a result of pass may be sent back.

The plug-in loader of the FFD_worker may maintain an FFD plug-in attribute object, which may include flags indicating whether the handler list for each individual type is empty. The object may be updated every time the plug-in loader loads or reloads the plug-ins, and can be obtained by the filtering clients.

The FFC embedded in the FD may obtain the FFD plug-in attribute from the FFD during its own initialization. However, the FFD and the FD are two separate daemons and, therefore, are asynchronized. For example, the FFD may be down during the FD's startup, and the FFD may reload plug-ins when the FD is running. An attribute ID, which is changed for each update of the object (i.e. each time plug-ins are loaded or reloaded), may be associated with the object to identify the update and be used to synchronize the FFD plug-in attribute between the FFC and the FFD.

FFD plug-in attribute 672 in the third column of FIG. 6 is an exemplary attribute with an ID of 12345. FFD plug-in attribute 672 reflects a distribution of plug-in attributes according to the example of FIG. 5. List 673 shows which plug-in attributes of handler list 500 are listed in FFD plug-in attribute 672.

As mentioned above, a list request for FFD plug-in attribute during the FFC's startup may fail or the FFD may be down at the moment. To make the FD independent of the FFD, an attribute ID of FFC plug-in attribute may be set to 0, and all attribute flags set to true. FFC plug-in attribute 671 illustrates such an initial attribute. In one embodiment, 0 may be a special value for the attribute Id, and used only on the client side when an up to date FFC plug-in attribute is not available.

The 0 attribute ID on data packet 674 transmitted by the FFC to the FFD may trigger a flag that FFC plug-in attribute 671 is in an initial state. Consequently, the FFD may send back a ST_wrong_ID message as shown in data packet 678 along with up to date FFD plug-in attribute 672 after successfully processing of a first filtering request with 0 attribute ID from the FFC. If a filter request is successfully completed, the FFD may send a ST_OK message as in data packet 675 along with corresponding FFD plug-in attribute update.

As described previously, the handler list may be empty for a particular attribute. If the FFD encounters such a situation, it may respond with a ST_unexpected message as shown with data packet 677.

FIG. 6 shows an exemplary operation of a front-end filtering system according to one embodiment of the present invention. The invention is not so limited, however. Commands and messages, as well as data packet and filter types other than those discussed above may be employed without departing from the scope and spirit of the invention.

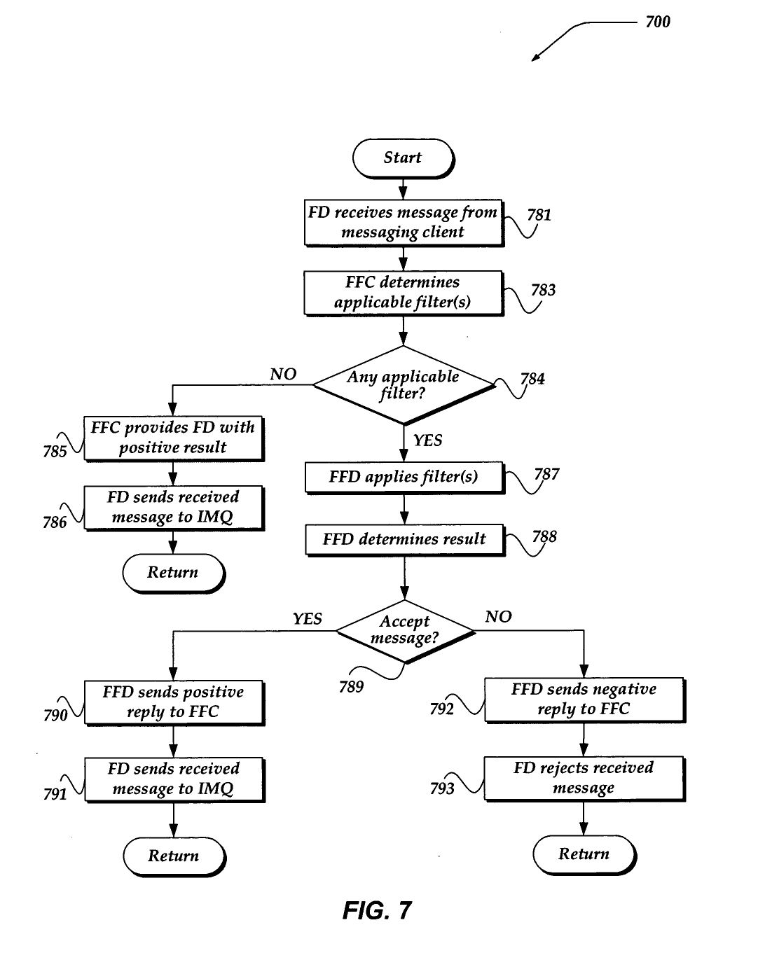

FIG. 7 illustrates a flow diagram generally showing a front-end filtering process 700 according to one embodiment of the present invention. Process 700 may, for example, be implemented in messaging server application 231 of FIG. 2.

As shown in FIG. 7, process 700 begins after a start block, at block 781, where FD receives a message from a messaging client. The message may include an email, an instant message, an MMS message, and the like. As described previously, FD includes a resident module FFC, which is configured to communicate with one or more FFD's employing a pre-defined format. The one or more FFD's are arranged to provide front-end filtering services.

The one or more FFD's may reside on a same messaging server as the FD. The one or more FFD's may also reside at a client server, a client application, and the like. While the FFC may typically be a module of the FD, in one embodiment, the FFC may also be a remote application. Furthermore, The one or more FFD's each may include at least one plug-in. The plug-ins may perform individual filtering tasks and be managed by a plug-in loader of each FFD. The FD-FFC-FFD-Plug-in architecture may enable a messaging system to share a plurality of filtering applications among a variety of front-end daemons, independently manage, modify, add, and remove each module of the architecture, and the like.

As mentioned above, the FFC communicates with the FFD employing a pre-defined format. Therefore, a filtering function may be completely transparent to the FD and the FFC may employ various FFD's without having a compatibility concern between the FFD's and the FD. Conversely, an FFD may also provide filtering services to a plurality of FD's. Processing then proceeds to block 783.

At block 783, the FFC determines applicable filters for the received message. An example of different filtering functions at an FFD is described in FIGS. 5 and 6. The FFC may have received a list of available filter from the FFD, for example, when the FFC starts up, when an attribute ID embedded in a filtering request doesn't match a current attribute, and when an unexpected request is received. In any event, during this block, The FFC and FFD may exchange at least one of a control command, a list command, and a filtering command. Block 783 is followed by block 784, where a decision is made whether the FFD has any applicable filters or not. If the decision is negative, processing proceeds to block 785. If the decision is affirmative, the processing proceeds to block 787.

At block 785, the FFC provides a positive reply to the FD. Because the FFD has no applicable filters, the message may be automatically accepted. In one embodiment, the FFC may be configured to know a list of applicable filters at the FFD, and avoid sending incoming messages to the FFD, for which no filter is applicable. This may save processing time and capacity. In another embodiment, the FFC may communicate with multiple FFD's and wait until all FFD's respond before providing a result to the FD. Processing then proceeds to block 786.

At block 786, the FD having received the positive result, sends the message to incoming message queue for further processing by other modules of the messaging system. Processing then proceeds to a calling process for further actions.

At block 787, the FFD applies applicable filter(s) to the message. Again, FIGS. 5 and 6 illustrate examples of various types of filters their application to incoming data. Processing then proceeds to block 788.

At block 788, the FFD determines a result of the filtering functions. A negative response from any of the applicable filters may constitute a rejection. On the other hand, if all filtering results are positive, an overall positive result may be determined. Processing then proceeds to decision block 789.

At block 789, a decision is made whether the message is to be accepted or not. If the decision if affirmative, processing proceeds to block 790. If the decision is negative, processing proceeds to block 792.

At block 790, the FFD sends a positive reply to the FFC, which in turn reports the positive reply to the FD. Processing then proceeds to block 791, where the FD sends the received message to incoming message queue for further processing by other modules of the messaging system.

At block 792, the FFD sends a negative reply to the FFC, which reports the negative reply to the FD. In the following block 793, the FD rejects the received message for failing at least one of the front-end filters. For a rejection, a connection can be aborted either immediately or after the FD forwards a returned rejection code to the messaging client following messaging protocol. Processing then proceeds to a calling process for further actions.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks. Moreover, the invention is not limited to the above listed examples, and other implementations may be employed, without departing from the spirit or scope of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions.

We claim:

1. A method for managing an incoming message in a messaging system, comprising:
receiving the message at a front-end daemon (FD);
determining whether front-end filtering is to be performed on the message;
if front-end filtering is to be performed, performing front-end filtering on the message at a front-end filtering daemon (FFD);
providing a result of the front-end filtering to the FD; and
if the result is positive, forwarding the filtered message to an incoming message queue for further processing by the messaging system.

2. The method of claim 1, wherein determining whether the front-end filtering is to be performed further comprises:
receiving from the FFD information about a plurality of available filters that are associated with the FFD; and
determining if at least one filter of the plurality of available filters is applicable to the message.

3. The method of claim 1, wherein determining whether front-end filtering is to be performed further comprises:
providing a front-end filtering client (FFC) module with information associated with a handler list, wherein the handler list includes information about a plurality of filters included in at least one plug-in module associated with the FFD.

4. The method of claim 3, wherein providing the FFC module with information further comprises exchanging at least one of a control command, a list command, and a filtering command between the FFC and the FFD.

5. The method of claim 1, wherein performing front-end filtering on the message comprises:
maintaining at the FFD a handler list;
determining at least one applicable filter among a plurality of filters;
applying the at least one applicable filter to the message, wherein each applicable filter includes at least one condition for the message;
if each condition for each applicable filter is complied with, providing the positive result to the FFC; and
if at least one condition for at least one applicable filter is not complied with, providing the negative result to the FFC.

6. The method of claim 5, wherein applying at least one applicable filter further comprises verifying if the message complies with at least one of having a client address associated with the message that is also included in a predetermined list of client addresses, having a client name associated with the message that is also included in a predetermined list of client names, having a message size being smaller than a predetermined message size limit, and having an IP address associated with the message that is also included in a predetermined list of IP addresses.

7. The method of claim 1, wherein performing front-end filtering on the message further comprises:
structuring the FFD to include an FFD_master and an FFD_worker, wherein the FFD_master is arranged to manage the FFD_worker.

8. The method of claim 7, wherein structuring the FFD further comprises employing, at the FFD_worker, a plug-in loader that is arranged to manage at least one plug-in module associated with the FFD.

9. The method of claim 1, wherein the FFD and the FD are arranged to operate on separate network devices.

10. The method of claim 1, wherein the FFD and the FD are arranged to operate on a same network device.

11. The method of claim 1, wherein processing by the messaging system further comprises at least one of sorting front-end filtered messages, collecting statistical information about the message, scanning the message for at least one virus, and forwarding the message to another destination in the network.

12. The method of claim 1, further comprising:
if the result is negative, rejecting the message, and at least one of sending a communication to a sender of the message based on a rejection code provided by the FFD, and breaking a connection with the sender of the message.

13. The method of claim 1, wherein the message further comprises at least one of an email, an MMS mail, an instant message, an HTTPS message, and an SMTP message.

14. A network device for processing an incoming message in a messaging system, comprising:
a memory device that is arranged to store machine readable instructions for processing of the incoming message; and
a processor that is in communication with the memory device, and is configured to execute at least one of the machine readable instructions, wherein the machine readable instructions comprise:
a front-end daemon (FD) arranged to receive the incoming message and to forward the message based on a positive result associated with a front-end filtering operation; and
a front-end filtering client module (FFC) arranged to communicate with a front-end filtering daemon (FFD) associated with a plurality of filters, to determine if the message is to be forwarded based on the communication with the FFD, and to provide the FD with a result of the determination.

15. The network device of claim 14, wherein the FFC is arranged to perform further actions, including:
determining if at least one filter of the plurality of filters is applicable to the message; and
if at least one filter of the plurality of filters is applicable, enabling the FFD to perform the front-end filtering operation, receiving a reply from the FFD associated with the front-end filtering operation, and providing the result to the FD.

16. The network device of claim 14, wherein the FFC is arranged further to exchange with the FFD at least one of a control command, a list command, a filtering command, and data employing a pre-defined format that is different from another pre-defined format employed for a communication between the FFC and the FD.

17. The network device of claim 14, wherein the FFC is arranged further to exchange with the FFD at least one of a control command, a list command, a filtering command, and data employing a pre-defined format that is also employed for a communication between the FFC and the FD.

18. The network device of claim 14, wherein the FFD is further arranged to employ at least one plug-in module associated with at least one filter in the plurality of filters for performing the front-end filtering operation, wherein at the network device is enables at least one of editing, removing, and adding of the at least one plug-in module.

19. The network device of claim 18, wherein the at least one filter further comprises at least one of a client address associated with the incoming message, a client name associated with the incoming message, an incoming message size, a destination address associated with the incoming message, and an IP address associated with the incoming message.

20. The network device of claim 14, wherein the processor is arranged to execute further machine readable instruction that enable at least one of sorting messages, collecting statistical information about the message, scanning the message for viruses, and forwarding the message to another destination in the network.

21. The network device of claim 14, wherein the FD is arranged to perform further actions comprising at least one of rejecting the message by sending a communication to a sender of the message based on a rejection code provided by the FFD, and rejecting the message by breaking a connection with the sender of the message.

22. The network device of claim 14, wherein the FFD and the FD are each arranged to operate on separate network devices.

23. A messaging system for exchanging messages over a network, comprising:
a first network device that is comprises:
a front-end daemon (FD) that is configured to perform actions, including:
receiving an incoming message; and
performing at least one of forwarding the message, and rejecting the message, based on a result associated with front-end filtering of the message; and
a front-end filtering client (FFC) module in communication with the FD that is configured to perform actions, including:
determining if front-end filtering is to be performed on the message;
if front-end filtering is to be performed, enabling front-end filtering on the message by a front-end filtering daemon (FFD);
receiving the result associated with front-end filtering on the message;
if the result is positive, requesting that the FD forward the message
if the result is negative, requesting that the FD reject the message; and
a second network device that is arranged to communicate with the FFD, wherein the FFD is further configured to perform front-end filtering on the message employing at least one filter.

24. The messaging system of claim 23, wherein the first network device is arranged to perform actions, further comprising:
if the result associated with front-end filtering is positive, performing at least one of sorting the incoming message, collecting statistical information about the incoming message, scanning the incoming message for at least one virus, and forwarding the incoming message to another destination in the network; and
if the result associated with front-end filtering is negative, performing at least one of sending a communication based on a rejection code, and breaking a connection with a messaging client.

25. The messaging system of claim 23, wherein the FFD further comprises:
an FFD_worker module that is arranged to perform at least one of communicating with the FFC, interfacing with at least one plug-in module, and performing the front-end filtering on the message; and
an FFD_master module that is arranged to manage the FFD_worker module.

26. The messaging system of claim 25, wherein the FFD_worker module further comprises:
a handler list that comprises information associated with the at least one filter;
a plug-in loader that is arranged to interface with the at least one plug-in module; and
a task manager that is arranged to perform actions including:
determining if at least one filter is applicable to the message;
if an applicable filter is unavailable, providing an acceptance code to the FFC;
if at least one applicable filter is available:
applying the at least one applicable filter to the message, wherein each applicable filter includes a condition for the message; and
providing a code to the FFC, wherein the code indicates if the condition of the applicable filter is complied with.

27. The messaging system of claim 23, wherein the FFD is configured to enable at least one of editing, removing, and adding on the at least one plug-in module.

28. The messaging system of claim 23, wherein the second network device is at least one of a router, a firewall, a network translation device, a server, and a client device.

29. A network device for processing an incoming message in a messaging system, comprising:
a means for receiving the incoming message;
a means for determining if front-end filtering is to be performed on the incoming message;
a means for determining at least one applicable filter from among a plurality of filters;
a means for applying the at least one applicable filter to the incoming message;
a means for receiving a result of front-end filtering for the incoming message; and
a means for performing at least one of forwarding the incoming message for further processing, and rejecting the incoming message, based on the result of front-end filtering on the incoming message.
